(19) United States
(12) Patent Application Publication
(10) Pub. No.: US 2025/0153367 A1
(43) Pub. Date: May 15, 2025

(54) GRIPPER WITH VARIABLE LOOP AND ITS CONTROL METHOD

(71) Applicant: KOREA INSTITUTE OF SCIENCE AND TECHNOLOGY, Seoul (KR)

(72) Inventors: Kahye SONG, Seoul (KR); Gyeongji KANG, Seoul (KR); Bum-Jae YOU, Seoul (KR); Jun Pil CHOE, Seoul (KR)

(73) Assignee: KOREA INSTITUTE OF SCIENCE AND TECHNOLOGY, Seoul (KR)

(21) Appl. No.: 18/656,135

(22) Filed: May 6, 2024

(30) Foreign Application Priority Data
Nov. 9, 2023 (KR) 10-2023-0154364

(51) Int. Cl. B25J 15/00; B25J 15/06; B25J 15/12

(52) U.S. Cl. CPC B25J 15/0033; B25J 15/0658; B25J 15/12

(57) ABSTRACT

The present disclosure relates to a gripper and grippers capable of being easily combined to safely grip and transfer objects with various and complicated shapes. In order to achieve the above-mentioned object, the technical aspects of the present disclosure provides a gripper including a variable loop having one end fixed to a transfer means and configured to surround and grip an object while being curved in a closed shape by air introduced into an air chamber in the variable loop, and a locking means configured to lock the variable loop when the variable loop is curved in a closed shape to maintain the closed shape.

### CROSS REFERENCE TO RELATED APPLICATION

This application claims the benefit under 35 USC 119 (a) of Korean Patent Application No. 10-2023-0154364 filed on Nov. 9, 2023, in the Korean Intellectual Property Office, the entire disclosure of which is incorporated herein by reference for all purposes.

### BACKGROUND OF THE INVENTION

### Field of the Invention

The present disclosure relates to a gripper, which is configured to grip an object to transfer the object, and a method of controlling the same, and more particularly, to a gripper configured to grip and pick up an object and transfer the object by using tension of a variable loop, thereby stably picking up a heavy object, the gripper being lightweight and soft to prevent damage to an object. Further, the present disclosure relates to grippers capable of being easily combined to safely grip and transfer objects with various and complicated shapes.

### DESCRIPTION ABOUT NATIONAL RESEARCH AND DEVELOPMENT SUPPORT

This study was supported by the technology development programs of Ministry of Science and ICT, Republic of Korea (Projects No. 1711201171 and No. 1711200728) under the superintendence of National Research Foundation of Korea and Korea Institute of Science and Technology.

### DESCRIPTION OF THE RELATED ART

In order to move a position of an object, it is typically necessary to provide a gripper configured to grip the object, and a transfer means configured to pick up the object at the current position and transfer the object to a destination.

Representatively, a robot arm, a conveyor, a hydraulic system with a telescopic stroke, or the like may be used as the transfer means. When the gripper grips the object, the transfer means operates to pick up the object, moves to a desired position, and then drops the object at the destination.

In the drawings, FIG. 1 is a conceptual view illustrating a gripper mounted at a distal end of a robot arm in the related art, and FIG. 2 is a conceptual view illustrating a configuration in which the gripper illustrated in FIG. 1 presses and picks up an object.

As illustrated in FIG. 1, a robot arm 1 is designed to have an articulated structure and configured to transfer an object 5 within an available range of the robot arm 1.

A gripper 3 is mounted at a distal end of the robot arm 1, and the gripper 3 grips the object 5 by pressing a lateral surface of the object 5.

In this case, a force (hereinafter, referred to as a ‘grasping force’) applied to the lateral surface of the object 5 by the gripper 3 needs to be higher than a load of the object 5. This is to prevent the object 5 from slipping off the gripper 3 and falling when the robot arm 1 transfers the object 5.

Therefore, an appropriate gripper needs to be selected depending on the weights or shapes of objects and then mounted on the robot arm. In case that the objects are atypical and also have different weights, it is inconvenient to select the appropriate gripper each time and mount the selected gripper on the robot arm.

In addition, in order to generate a high grasping force, a capacity of an actuator also needs to be increased proportionally. In this case, the weight and volume of the actuator is generally increased. In case that the weight and volume of the actuator are increased, a payload increases when the gripper is mounted on the robot arm or conveyor that is the transfer means, which causes a problem in that the capacity of the transfer means also needs to be increased proportionally.

In addition, FIG. 2 illustrates a process in which the gripper 3 grips the object 5 having a structure in which the lateral surface of the object 5 is vertical. In case that the object 5 has a concave or convex shape, there is a problem in that the points at which a left gripper 3L and a right gripper 3R come into contact with the object 5 are unstable, and the gripper loses the object 5 because a center of gravity of the object 5 changes during the process of picking up the object 5.

In order to transfer various types of objects with various shapes, various types of grippers need to be provided, and there is inefficiency in having to often change the grippers depending on the objects.

In addition, although not illustrated in the drawings, in the case of a gripper that sucks and transfers objects by using a suction plate, the suction plate needs to be periodically managed in order to ensure a suction force applied to the object. Further, components, such as a vacuum pump or a compressor, for maintaining a vacuum state on the inside of the suction plate need to be provided as separate essential components outside the robot arm. In general, the gripper having the suction plate is applied only to grip a lightweight object, and a large-scale gripper having a plurality of suction plates needs to be provided to grip a heavy object, which increases the capacity of the transfer means.

In the drawings, FIG. 3 is a conceptual view illustrating a pneumatic gripper and a gripper system in the related.

A pneumatic gripper illustrated in FIG. 3 is a publicly-known technology disclosed in Korean Patent No. 10-2222633 (Mar. 5, 2021). A configuration and operational relationship of the pneumatic gripper will be described below.

The pneumatic gripper includes a finger part 10 having an accommodation portion 17 capable of accommodating air, the finger part 10 being configured to be deformed while being bent by internal expansion when air is supplied to the accommodation portion 17, a pumping part 20 formed to be compressed and expanded and configured to accommodate the accommodation portion 17 so as to supply air to the accommodation portion 17, and a connector 30 provided between the finger part 10 and the pumping part 20 and equipped with the finger part 10 and the pumping part 20 so that the inside of the accommodation portion 17 and the inside of the pumping part 20 may communicate with each other. When the pumping part 20 is compressed, the air in the pumping part 20 is supplied to the accommodation portion of the finger part 10, such that the pneumatic gripper grips objects as the accommodation portion 17 operates while being bent.

The pneumatic gripper disclosed in Korean Patent No. 10-2222633 (Mar. 5, 2021) is configured such that when the pumping part 20 supplies air into the accommodation portion 17 of the finger part 10, the finger part 10 is curved, and the curved finger part 10 surrounds and grips the object.

In case that the gripper is designed as the pneumatic gripper, which is operated by pneumatic pressure and surrounds and grips the object with the finger part or the gripper that presses and grips the lateral surface of the object with the end of the finger part, as illustrated in FIG. 2, a high grasping force is required as described above, there is a problem in that the pneumatic pressure for satisfying the condition is inevitably increased, and the volume and weight of the gripper are also increased.

### Documents of Related Art

(Patent Document 1) Korean Patent No. 10-2222633 (Mar. 5, 2021)
(Patent Document 2) Korean Patent No. 10-2555319 (Jul. 14, 2023)
(Patent Document 3) Fabric-based Actuator Modules for Building Soft Pneumatic Structures with High Payload-to-Weight Ratio, Khin, P. M. et al. 2017
(Patent Document 4) Design Analysis of a Fabric Based Lightweight Robotic Gripper, Hassan, A. et al. 2019
(Patent Document 5) A Bidirectional Soft Pneumatic Fabric-based Actuator for Grasping Applications, Low, J. H. et al. 2017
(Patent Document 6) Design, Characterization, and Implementation of a Two-DOF Fabric-Based Soft Robotic Arm, Liang, X. et al. 2018

### SUMMARY OF THE INVENTION

The present disclosure has been made in an effort to solve the above-mentioned problem in the related art, and an object of the present disclosure is to provide a variable loop gripper configured such that a variable loop configured to be operated by a pneumatic pressure surrounds an object, and the gripper picks up the surrounded object by using tension of the variable loop, which makes it possible to surround the object with a low pneumatic pressure and to pick up the object with high tension, and a method of controlling the same.

The present disclosure has also been made in an effort to provide a variable loop gripper, in which a variable loop and a spiral loop are combined, the variable loop may grip an object, which is long in length or has a handle, and the spiral loop may grip objects with various shapes, and a method of controlling the same.

In order to achieve the above-mentioned object, the technical aspect of the present disclosure provides a gripper including: a variable loop configured to surround and grip an object while being curved in response to an external signal; and a locking means configured to lock the variable loop when the variable loop is curved in a closed shape to maintain the closed shape.

In addition, according to the exemplary embodiment of the present disclosure, one end of the variable loop may be fixed to a transfer means.

In addition, according to the exemplary embodiment of the present disclosure, the variable loop may have a band shape, and a plurality of elastic members with a band shape may be joined to one another along edges thereof to form an air chamber therein.

In addition, according to the exemplary embodiment of the present disclosure, one or more folding portions, where the elastic members are joined, may be formed in a longitudinal middle portion of the air chamber in a width direction of the air chamber, and the folding portion may be joined to have a length smaller than a width of the air chamber so that air flows.

In addition, according to the exemplary embodiment of the present disclosure, the variable loop may be made of a flexible material and has a band shape, folding portions may be formed on a curved inner surface of the variable loop and disposed at intervals, rings may be formed on an outer surface of the variable loop and disposed at intervals in a longitudinal direction of the variable loop, and the gripper may include: a wire having an end fixed to an end of the variable loop and configured to penetrate the ring and extend in the longitudinal direction of the variable loop; and a motor configured to move the wire.

In addition, according to the exemplary embodiment of the present disclosure, the wire may be a bent elastic wire, the variable loop may have a closed shape curved along a shape of the clastic wire, and the variable loop may change to an opened shape as the wire is moved to the outside of variable loop by the motor.

In addition, according to the exemplary embodiment of the present disclosure, the variable loop may be made by attaching two types of materials that are differently stretched or contracted in response to the external signal, and the variable loop may be curved in the closed shape or deployed in an opened shape in response to the external signal.

In addition, according to the exemplary embodiment of the present disclosure, the variable loop may be made by attaching polymers with different flexibility.

In addition, according to the exemplary embodiment of the present disclosure, the variable loop may be made by attaching metallic materials with different flexibility.

In addition, according to the exemplary embodiment of the present disclosure, the locking means may include a magnet and a magnetic element, one of the magnet and the magnetic element may be fixed to one of two opposite ends of the variable loop or the transfer means, the other of the magnet and the magnetic element may be fixed to a free end that is the other end of the variable loop, and when the variable loop is curved in the closed shape, the magnet and the magnetic element may be attached by an attractive force to maintain the closed shape.

In addition, according to the exemplary embodiment of the present disclosure, the free end of the variable loop may be positioned between the magnet and the magnetic element that are attached to each other.

In addition, according to the exemplary embodiment of the present disclosure, enlarged portions may be respectively formed at two opposite ends of the variable loop, the first enlarged portion formed at one end of the variable loop may be fixed to the transfer means, and the locking means may be fixed to the first enlarged portion and the second enlarged portion formed at the free end of the variable loop.

In addition, according to the exemplary embodiment of the present disclosure, a second enlarged portion may be formed at a free end of the variable loop, and folding portions may be formed forward and rearward of the second enlarged portion in a direction in which air is introduced into the air chamber.

In addition, according to the exemplary embodiment of the present disclosure, a hose may be connected to the air chamber of the variable loop, and the gripper may further include a pneumatic system configured to inject or discharge air through the hose.

In addition, according to the exemplary embodiment of the present disclosure, a second enlarged portion may be formed at a free end of the variable loop, and an air chamber provided separately from the air chamber of the variable loop may be formed in the second enlarged portion.

In addition, according to the exemplary embodiment of the present disclosure, the gripper may further include: a pneumatic system having hoses respectively connected to the air chamber of the variable loop and the air chamber of the second enlarged portion, the pneumatic system being configured to inject or discharge air selectively into or from any one air chamber or both of the air chambers.

In addition, according to the exemplary embodiment of the present disclosure, the folding portion may be formed in any one of a rectilinear shape, an oblique shape, and a rhombic shape.

In addition, according to the exemplary embodiment of the present disclosure, the locking means may include a latch and a ring, the ring is fixed to a free end portion of the variable loop, the latch may be rotatably fixed to a shaft of a motor, the latch may penetrate the ring when the variable loop is curved in the closed shape, the ring may be locked so as not to be separated from the latch as the latch is rotated by an operation of the motor, and the ring may be unlocked while slipping off and separating from the latch as the latch is rotated by the motor.

In addition, according to the exemplary embodiment of the present disclosure, the motor may be fixed to one end of the variable loop or the transfer means.

In addition, according to the exemplary embodiment of the present disclosure, the latch may be an inclined straight bar extending from an end of the horizontal shaft of the motor, and a longitudinal middle portion of the straight bar may be bent at an obtuse angle.

In addition, according to the exemplary embodiment of the present disclosure, the locking means may be a gripper having a plurality of spiral loops configured to converge or diverge, and one end of the variable loop may be fixed inside the spiral loops, in which when the variable loop is curved in the closed shape, the spiral loops may converge to lock and bind a free end of the variable loop, and the variable loop may be unlocked as the spiral loops diverge.

In addition, according to the exemplary embodiment of the present disclosure, the gripper having the plurality of spiral loops configured to converge or diverge may include: an upper plate; a lower plate configured to rotate relative to the upper plate; and the plurality of spiral loops having two opposite ends respectively connected to the upper plate and the lower plate or extending from the upper plate and the lower plate, the plurality of spiral loops having twisted longitudinal middle portions, and the longitudinal middle portions of the spiral loops may converge or diverge as the upper plate and the lower plate rotate relative to each other.

In addition, according to the exemplary embodiment of the present disclosure, the upper plate may be mounted on the transfer means.

In addition, according to the exemplary embodiment of the present disclosure, an enlarged portion may be formed at a free end of the variable loop, and the spiral loops may surround and bind the enlarged portion.

In addition, according to the exemplary embodiment of the present disclosure, the locking means may include a locking part and an unlocking part, the locking part may include a magnet and a magnetic element, any one of the magnet and the magnetic element may be fixed to one of two opposite ends of the variable loop or the transfer means, the other of the magnet and the magnetic element may be fixed to a free end that is the other end of the variable loop, and when the variable loop is curved in the closed shape, the magnet and the magnetic element may be attached by an attractive force to maintain the closed shape.

In addition, according to the exemplary embodiment of the present disclosure, the unlocking part may be an elastic member formed in an air chamber in the variable loop, the elastic member may be fixed to a bottom surface of the magnetic element, the elastic member may be expanded by air injected into the air chamber or contracted as the air is discharged, and a free end of the variable loop may be attached to a bottom surface of the unlocking part.

Further, the technical aspect of the present disclosure provides a method of controlling a gripper with a variable loop, which is mounted on a transfer means and configured to surround and grip an object while being curved by a pneumatic pressure, the method including: allowing the variable loop to be curved to surround the object by injecting air into the variable loop; and gripping the object by locking a free end of the curved variable loop.

In addition, according to the exemplary embodiment of the present disclosure, the method may further include: transferring the gripped object to a desired position; and unlocking the variable loop to release the object.

In addition, according to the exemplary embodiment of the present disclosure, the method may further include: discharging air from the variable loop after the gripping of the object.

In addition, according to the exemplary embodiment of the present disclosure, the free end of the variable loop may be locked by attaching the free end of the variable loop to a fixed end of the variable loop or the transfer means by using a magnetic force.

In addition, according to the exemplary embodiment of the present disclosure, the free end of the variable loop may be locked to a fixed end of the variable loop or the transfer means by coupling a latch and a ring.

In addition, according to the exemplary embodiment of the present disclosure, an enlarged portion may be formed at the free end of the variable loop, and another gripper mounted on the transfer means may lock the free end of the variable loop by binding the enlarged portion.

As described above, according to the gripper and the method of controlling the same according to the present disclosure, the variable loop surrounds the object while changing to the closed shape, and the object is lifted by the tension of the variable loop, such that the gripper may lift up the heavy object, in comparison with the technology in the related art the lifts up the object by using a pneumatic pressure.

As described above, according to the gripper according to the present disclosure, the variable loop surrounds and grips the object while changing from the opened state to the closed state, such that the gripper may grip the object that is long in length or has a closed-type handle. Further, in case that the spiral loops are adopted as the locking means, the gripper may grip and transfer objects with various sizes.

In addition, the gripper according to the present disclosure has the simple structure and is light in weight, thereby reducing a payload loss of a manipulator.

### BRIEF DESCRIPTION OF THE DRAWINGS

FIG. 1 is a conceptual view illustrating a gripper mounted at a distal end of a robot arm in the related.

FIG. 2 is a conceptual view illustrating a configuration in which the gripper illustrated in FIG. 1 presses and grips an object.

FIG. 3 is a conceptual view illustrating a pneumatic gripper and a gripper system in the related art.

FIG. 4 is a perspective view illustrating a variable loop of a gripper according to an embodiment of the present disclosure.

FIG. 5 is an exploded perspective view illustrating elastic members the variable loop illustrated in FIG. 4.

FIG. 6 is a conceptual view for comparing thicknesses of the elastic members of the variable loop illustrated in FIG. 4.

FIG. 7 is a conceptual view illustrating a process in which the variable loop illustrated in FIG. 4 is locked while changing to a closed shape as air is injected into the variable loop.

FIG. 8 is a conceptual view illustrating an unlocking process performed from the locked state in FIG. 7.

FIG. 9 is a conceptual view of the gripper equipped with a locking means including a locking part and an unlocking part.

FIG. 10 is a conceptual view illustrating a configuration in which the variable loop illustrated in FIG. 9 is locked in a closed shape.

FIG. 11 is a conceptual view illustrating a configuration in which the variable loop illustrated in FIG. 10 is unlocked.

FIG. 12 is a top plan view illustrating another modified example of the variable loop.

FIG. 13 is a cross-sectional view illustrating a first air chamber and a second air chamber of the variable loop illustrated in FIG. 12.

FIG. 14 is a perspective view illustrating an example of a gripper equipped with a latch and a ring as locking means.

FIG. 15 is a conceptual view illustrating a state in which the variable loop having a closed shape is locked by using the latch and the ring illustrated in FIG. 14.

FIG. 16 is a conceptual view illustrating a configuration in which the variable loop in the locked state in FIG. 15 is unlocked.

FIG. 17A is a perspective view illustrating a modified example of the gripper according to the present disclosure in which the locking means is configured as a spiral loop.

FIG. 17B is a conceptual view illustrating a cross-section of the gripper illustrated in FIG. 17A.

FIG. 18 is a conceptual view illustrating an operational relationship of the spiral loops when viewed from the bottom side.

FIG. 19 is a conceptual view illustrating a process in which the variable loop illustrated in FIG. 17A is locked while changing to a closed shape as air is injected into the variable loop.

FIG. 20 is a conceptual view illustrating a configuration in which the variable loop illustrated in FIG. 19 is unlocked and opened.

FIG. 21 is a conceptual view illustrating another embodiment of the variable loop.

FIG. 22 is a conceptual view illustrating an operational relationship of the variable loop illustrated in FIG. 21.

FIG. 23 is a conceptual view illustrating still another embodiment of the variable loop.

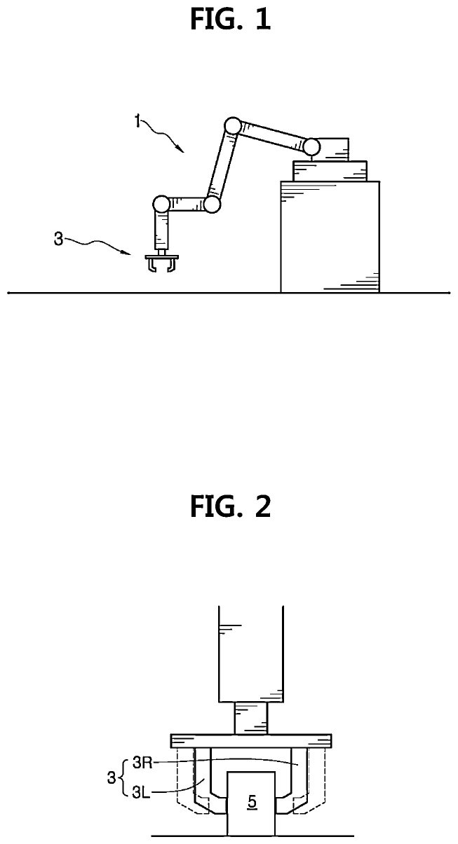

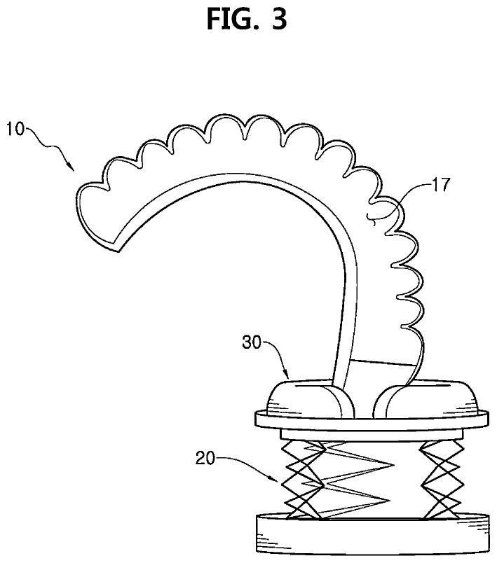

### DETAILED DESCRIPTION OF THE INVENTION

Hereinafter, exemplary embodiments of a gripper with a variable loop and a method of controlling the same according to the present disclosure will be described in detail with reference to the accompanying drawings.

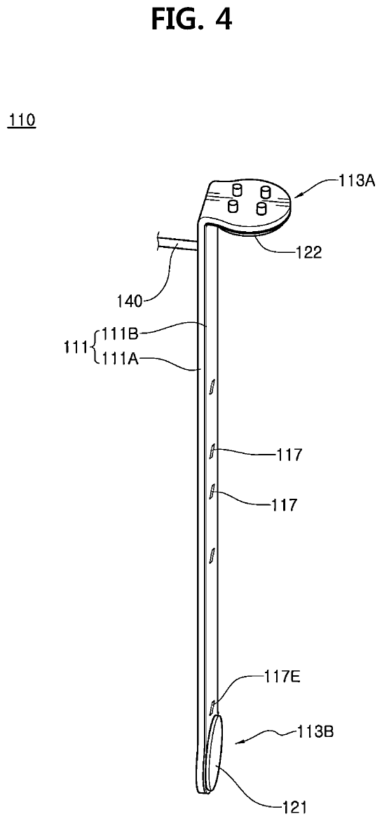

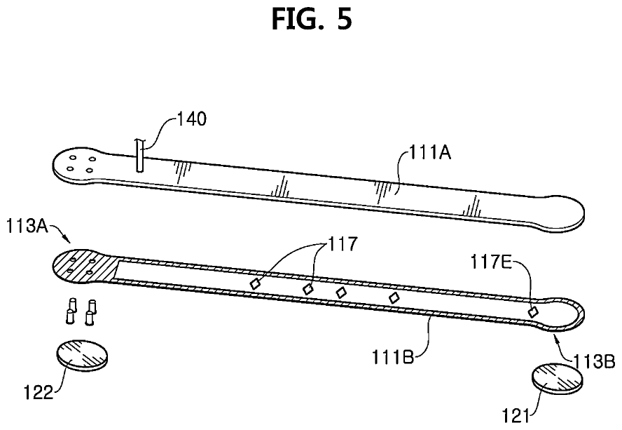

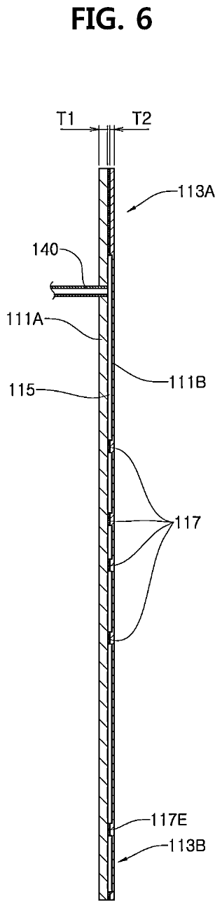

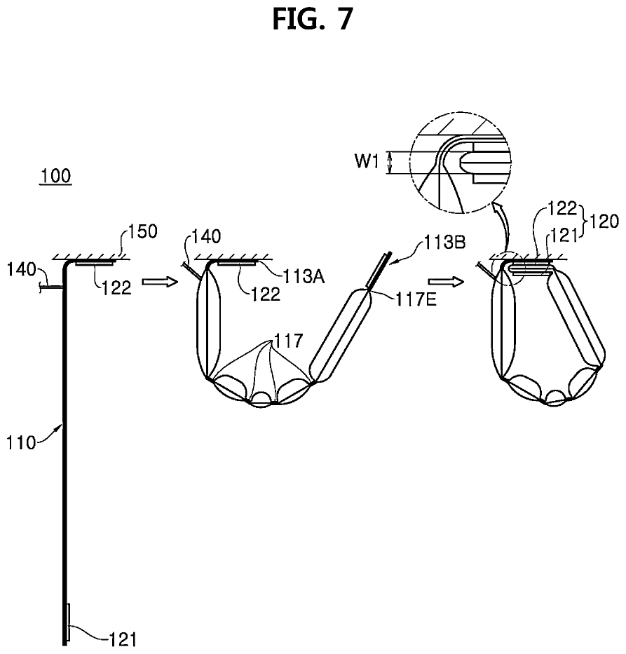

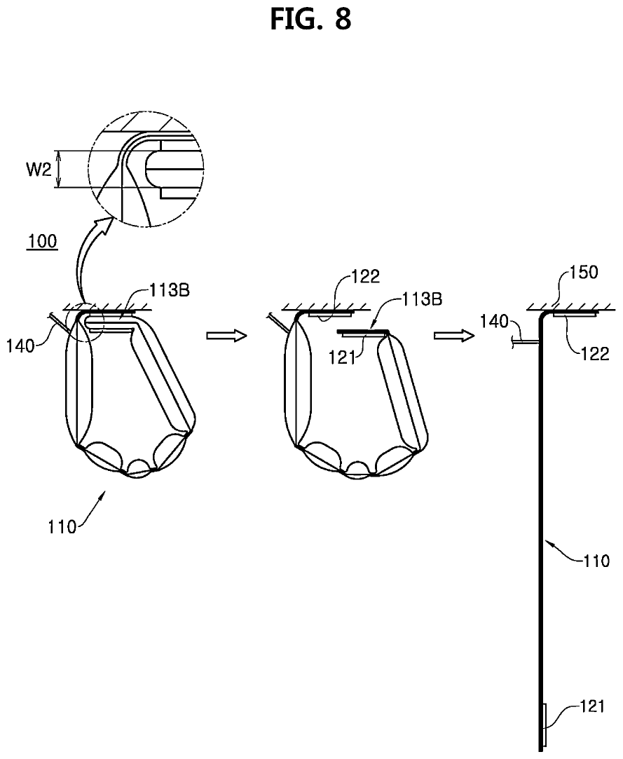

In the drawings, FIG. 4 is a perspective view illustrating a variable loop of a gripper according to an embodiment of the present disclosure, FIG. 5 is an exploded perspective view illustrating elastic members the variable loop illustrated in FIG. 4, and FIG. 6 is a conceptual view for comparing thicknesses of the elastic members of the variable loop illustrated in FIG. 4. Further, FIG. 7 is a conceptual view illustrating a process in which the variable loop illustrated in FIG. 4 is locked while changing to a closed shape as air is injected into the variable loop, and FIG. 8 is a conceptual view illustrating an unlocking process performed from the locked state in FIG. 7.

As illustrated in FIG. 4, a gripper 100 includes a variable loop 110 configured to be curved in a closed shape by a pneumatic pressure when air is injected, a pneumatic system configured to inject air into the variable loop 110 or discharge the air from the variable loop 110, and a locking means 120 configured to lock a free end of the variable loop 110 when the variable loop 110 is curved in the closed shape and to unlock the free end of the variable loop 110 so that the variable loop 110 may be deployed.

Hereinafter, the gripper configured as described above will be described specifically.

The variable loop 110 of the gripper 100 is a pneumatic actuator and configured to be curved in the closed shape by air injected into the variable loop 110. When the injected air is discharged, the variable loop 110 is deployed vertically downward by a load, as illustrated in FIG. 4.

As illustrated in FIGS. 4 and 5, the variable loop 110 has a band structure having a length relatively larger than a width. The variable loop 110 has a hollow shape so that the air may be injected into the variable loop 110.

More specifically, the variable loop 110 includes elastic members 111 made of a composite material and made by coating a fabric with thermoplastic polyurethane. The variable loop 110 applies high tension by means of elasticity made by thermoplastic polyurethane (TPU) and the fabric that is a tendon.

As illustrated in FIG. 5, two sheets of elastic members 111 are stacked, and an edge of the elastic member 111 and folding portions 117 and 117E to be described below are joined by thermal bonding (corresponding to hatched portions in FIG. 5) or the like, such that the air chamber 115 is formed in the variable loop 110.

Meanwhile, as illustrated in FIG. 6, in the two sheets of elastic members 111, an elastic member (hereinafter, referred to as a ‘first elastic member 111A’), which is positioned at an outer side based on a direction in which the variable loop 110 is curved when the air is injected into the variable loop 110, has a larger thickness than an elastic member (hereinafter, referred to as a ‘second elastic member 111B’) positioned at an inner side (T1>T2). The reason why the first elastic member 111A and the second elastic member 111B are different in thicknesses is that the variable loop 110 is curved toward the inner side at which the second elastic member 111B having a small thickness is positioned when the first elastic member 111A at the outer side and the second elastic member 111B at the inner side are expanded together as the air is injected into the air chamber 115.

In addition, the folding portions 117 are provided in the air chamber 115 and disposed at intervals in a longitudinal middle portion of the variable loop 110 so that the variable loop 110 may be curved in the closed shape by the injected air. The folding portion 117 is a portion where the first elastic member 111A and the second elastic member 111B are joined to each other. When the variable loop 110 is curved in the closed shape, the folding portion 117 serves as a hinge. To this end, as illustrated in FIG. 5, the folding portion 117 may be formed in a rhombic shape. Even though the folding portions 117 and 117E are formed in a straight or oblique shape instead of the rhombic shape, the functions of the folding portions may be implemented.

A part of a widthwise middle portion of the air chamber 115 is joined, such that the air may flow to the entire air chamber 115 through an opened side that is not joined.

In case that the folding portions 117 are formed at predetermined intervals in a longitudinal direction of the variable loop 110, the loop 110 changed to the closed shape has a circular shape. As illustrated in FIG. 5, when the interval between the folding portions 117 is small, the loop 110 is curved with a small radius of curvature. That is, the interval between the folding portions 117 is proportional to the radius of curvature of the variable loop 110.

Therefore, in case that the interval between the folding portions 117 formed on the longitudinal middle portion of the variable loop 110 is decreased, the variable loop 110 is curved in a long elliptical shape. As described above, the shape in which the variable loop 110 is curved may be adjusted by the interval between the folding portions 117.

In the longitudinal direction of the variable loop 110, one end of the length is a fixed end portion fixed to the transfer means 150, and the other end of the length is a free end portion. The free end portion has a structure that is easily locked by the locking means 120 in the state in which the variable loop 110 is curved in the closed shape.

The fixed end portion and the free end portion of the variable loop 110 illustrated in FIG. 5 are formed as enlarged portions 113A and 113B with a circular shape having a diameter larger than the width of the longitudinal middle portion.

The first enlarged portion 113A formed at one end has bolt holes so that the first enlarged portion 113A may be fixed to the transfer means 150 as described above, and a magnetic element 122 is fixed to the first enlarged portion 113A of the variable loop 110. Further, a permanent magnet 121 is fixed to the second enlarged portion 113B of the variable loop 110 and fixed to the other end of the second elastic member 111B.

In the variable loop 110 illustrated in FIGS. 7 and 8, the locking means 120 includes the permanent magnet 121 and the magnetic element 122. When the air is injected into the variable loop 110, the variable loop 110 is curved based on the folding portions 117 as hinge points, and the second enlarged portion 113B, i.e., the permanent magnet 121 moves toward the magnetic element 122 fixed to the first enlarged portion 113A. When the permanent magnet 121 approaches the magnetic element 122 and enters a magnetic field, the permanent magnet 121 is fixedly attached to the magnetic element 122 by an attractive force of the permanent magnet 121.

In this case, the second enlarged portion 113B of the variable loop 110 is positioned between the permanent magnet 121 and the magnetic element 122 attached to each other. To this end, as illustrated in FIG. 5, in an air inflow direction, the folding portion 117E is formed at an upstream side of the second enlarged portion 113B, i.e., formed forward of the second enlarged portion 113B. The second enlarged portion 113B is bent inward by the folding portion 117E formed forward of the second enlarged portion 113B. In this state, the second enlarged portion 113B is moved toward the first enlarged portion 113A, and the permanent magnet 121 is attached to the magnetic element 122, such that the second enlarged portion 113B is positioned between the permanent magnet 121 and the magnetic element 122.

Further, a hose 140 of the pneumatic system is connected to one end of the variable loop 110 and connected to the inside of the air chamber 115, such that the air is injected into the air chamber 115 through the hose 140. Alternatively, the pneumatic system is opened, such that the air in the air chamber 115 is discharged to the outside.

In an initial step before air is injected into the air chamber 115, the variable loop 110 is positioned to be extended downward by a load thereof, as illustrated in FIG. 4.

In this state, when the pneumatic system is controlled and the air is injected into the air chamber 115 in the variable loop 110, the variable loop 110 is expanded. In this case, the thin second elastic member 111B is expanded greatly than the thick first elastic member 111A, the variable loop 110 is bent about the folding portions 117 and curved in a shape in which the first elastic member 111A is positioned at the outer side. The variable loop 110 is curved to surround an object having a long structure. Further, when the variable loop 110 is curved, the second enlarged portion 113B moves toward and approaches the first enlarged portion 113A.

Meanwhile, the second enlarged portion 113B is further bent inward by the folding portion 117E positioned forward of the second enlarged portion 113B, and the second enlarged portion 113B is fixedly attached to the magnetic element 122 while being positioned between the permanent magnet 121 and the magnetic element 122 by the attractive force of the permanent magnet 121 fixed to the second enlarged portion 113B.

Because the permanent magnet 121 and the magnetic element 122, which are the locking means 120, are attached by the magnetic force as described above, the variable loop 110 is kept in the closed shape, and the object is positioned in a state of being gripped in the variable loop 110 having the closed shape even though the air in the air chamber 115 is discharged by the pneumatic system.

In this state, in case that the transfer means 150 is moved upward, the object may be lifted up by tension of the fabrics, i.e., the tendons provided in the elastic members 111A and 111B.

In the related art, an object is gripped and then lifted up by a pneumatic pressure applied to an actuator. In contrast, the present disclosure differs from the related art in that the heavy object is lifted up by the tension of the elastic members 111A and 111B while the closed shape of the variable loop 110 is stably maintained by the locking means 120.

Meanwhile, after the object is transferred to a desired position in the state in which the object is lifted up by the variable loop 110, air is injected into the air chamber 115. Therefore, the air is introduced into the second enlarged portion 113B, and the second enlarged portion 113B is also expanded, such that the interval between the permanent magnet 121 and the magnetic element 122 is increased. The magnetic element 122 moves away from the permanent magnet 121 to the outside of the magnetic field range, and as a result, the second enlarged portion 113B of the variable loop 110 is separated from the first enlarged portion 113A and unlocked. In this case, when the air in the air chamber 115 is discharged, the variable loop 110 is deployed downward, i.e., to the initial state and releases the object, as illustrated in FIG. 4.

During the locking and locking processes of the locking means 120, an expansion degree (W2 in FIG. 8) of the second enlarged portion 113B during the unlocking process is higher than an expansion degree (W1 in FIG. 7) of the second enlarged portion 113B during the locking process. This is because the attractive force needs to be applied between the permanent magnet 121 and the magnetic element during the locking process, whereas the second enlarged portion 113B needs to be expanded during the unlocking process so that the magnetic element 122 needs to be positioned outside the magnetic force of the permanent magnet 121.

The configuration has been described above in which the locking means 120 of the gripper 100 includes the permanent magnet 121 fixed to the free end portion of the variable loop 110, and the magnetic element 122 fixed to the fixed end portion of the variable loop 110 or the transfer means 150. However, the locking means 120 to be described below includes a locking part 127 and an unlocking part 128 provided as separate components.

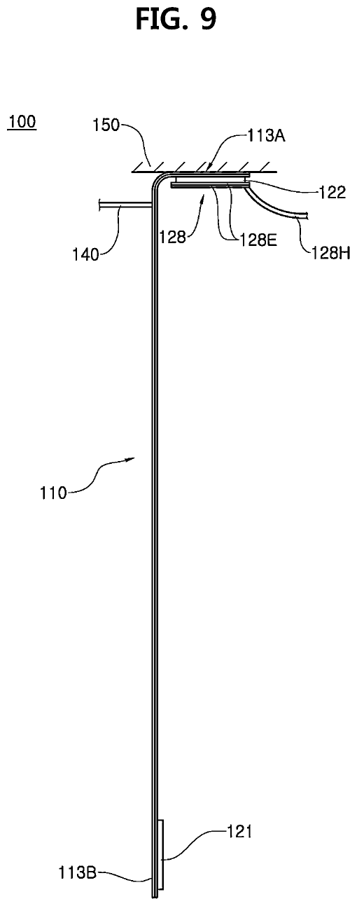

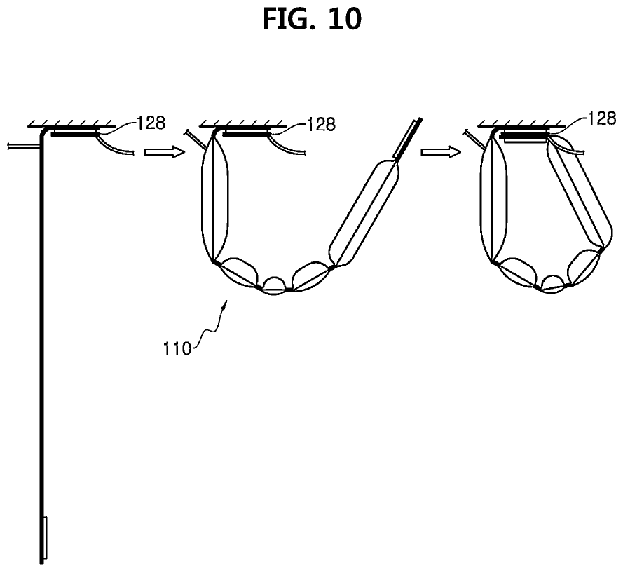

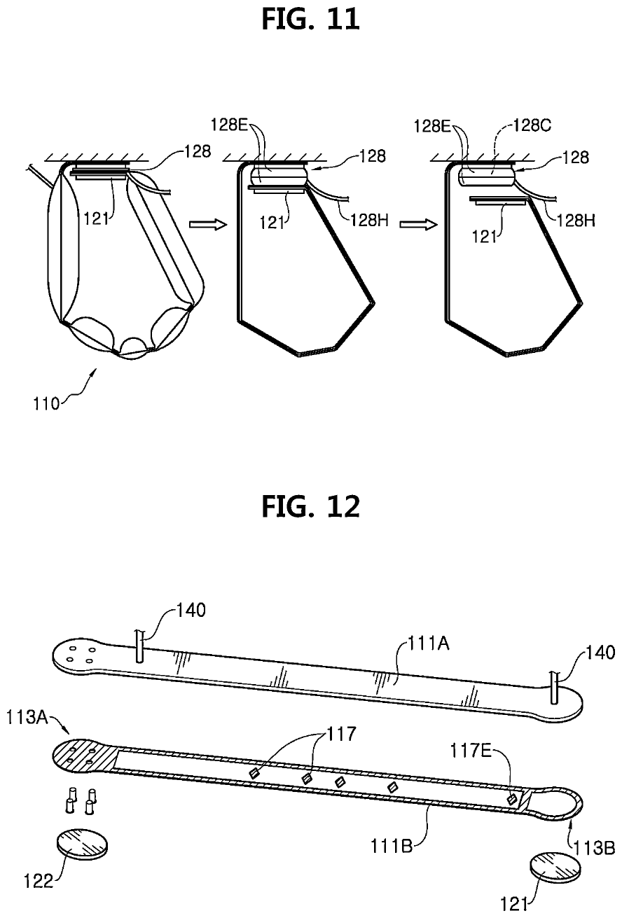

In the drawings, FIG. 9 is a conceptual view of the gripper equipped with a locking means including a locking part and an unlocking part, FIG. 10 is a conceptual view illustrating a configuration in which the variable loop illustrated in FIG. 9 is locked in a closed shape, and FIG. 11 is a conceptual view illustrating a configuration in which the variable loop illustrated in FIG. 10 is unlocked.

The locking part 127 includes the permanent magnet 121 and the magnetic element 122 and are mounted on the variable loop 110 and the transfer means 150 in the same way described above.

However, the unlocking part 128 is positioned on a bottom surface of the magnetic element 122 and configured to expand during the unlocking process. Therefore, a specific description of the locking part 127 will be omitted, and the unlocking part 128 will be described below.

As illustrated in FIGS. 9 to 11, the unlocking part 128 has a structure in which a plurality of elastic members 128E is stacked, and edges of the elastic members 128E are joined. A hose 128H is connected to the unlocking part 128, such that air is injected into an air chamber 128C in the unlocking part 128, and the air is discharged from the air chamber 128C. In this case, the hose 128H is configured to inject or discharge the air independently of the hose 140 connected to the variable loop 110.

Therefore, when the air is injected through the hose 128H of the unlocking part 128, the unlocking part 128 fixed to the bottom surface of the magnetic element 122 performs the unlocking process while expanding. This configuration is identical in operational principle to the above-mentioned configuration in which the second enlarged portion 113B is expanded to position the magnetic element 122 outside the magnetic force of the permanent magnet 121.

The operational relationship of the gripper 100 configured as described above will be described. The initial state is a state in which the air is discharged from the air chambers 115 and 128C of the variable loop 110 and the unlocking part 128. Thereafter, when the air is injected into the variable loop 110 to perform the locking process, the variable loop 110 grips the object while being curved in the closed shape as described above, the permanent magnet 121 fixed to the second enlarged portion 113B is moved toward the magnetic element 122 and attached to the magnetic element 122. As described above, the permanent magnet 121 and the magnetic element 122 of the locking part 127 are fixedly attached by the magnetic force, such that the variable loop 110 is kept in the closed shape. As necessary, the state in which the air in the air chamber 115 is discharged to the outside is maintained.

The air is injected into the unlocking part 128 to perform the unlocking process. Therefore, the unlocking part 128 is expanded, and the permanent magnet 121 is moved downward, such that the permanent magnet 121 is unlocked as the magnetic element 122 is positioned outside the magnetic force range of the permanent magnet 121. In this case, when the air in the air chamber 115 is discharged to the outside, the variable loop 110 is deployed vertically downward. Further, the air in the air chamber 128C of the unlocking part 128 is discharged to the outside, such that the air chamber 128C is kept in a contracted state.

In the above-mentioned two embodiments, the examples have been described in which the air chamber 115 of the variable loop 110 is configured as a single air chamber. However, air chambers 115A and 115B may be respectively provided in the longitudinal middle portion and the second enlarged portion 113B of the variable loop and controlled independently.

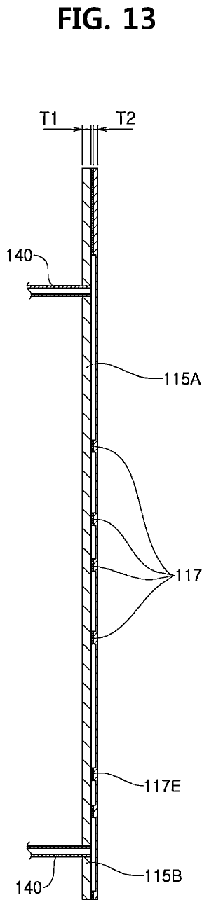

In the drawings, FIG. 12 is a top plan view illustrating another modified example of the variable loop, and FIG. 13 is a cross-sectional view illustrating a first air chamber and a second air chamber of the variable loop illustrated in FIG. 12.

For convenience, the air chamber formed in the longitudinal middle portion of the elastic member 111 will be referred to as a ‘first air chamber 115A’, and the air chamber formed in the second enlarged portion 113B will be referred to as a ‘second air chamber 115B’. The hoses 140 may be respectively connected to the first air chamber 115A and the second air chamber 115B and independently inject or discharge the air.

In this case, when the air is injected into the first air chamber 115A having the folding portions 117 and 117E, the variable loop 110 is curved in the closed shape. When the air is injected into the second air chamber 115B after the locking is performed in the state in which the variable loop 110 changes to the closed shape, the second enlarged portion 113B is expanded, such that the permanent magnet 121 separates from the magnetic element 122.

Further, when the air in the first air chamber 115A is discharged, the variable loop 110 is deployed downward by the weight thereof, as illustrated in FIG. 4.

As described above, in the modified example, the shape of the variable loop 110 may be controlled by injecting or discharging the air into or from the first air chamber 115A. The processes of locking and unlocking the permanent magnet 121 and the magnetic element 122 of the locking means 120 may be controlled by injecting or discharging the air into or from the second air chamber 115B.

As described above, in the present disclosure, the locking process is performed by the locking means 120 so that the variable loop 110 is not opened in the closed state in which the variable loop 110 is changed to the closed shape while surrounding the object, such that the object may be lifted up.

In the gripper 100 configured as described above, electromagnets may be selected instead of the permanent magnet 121 and the magnetic element 122. In addition, the locking means may be variously modified and configured.

An embodiment will be specifically described below in which a latch 124, which is rotated by a step motor 123, and a ring 125, which is fixed to the free end of the variable loop 110, are provided as the locking means 120.

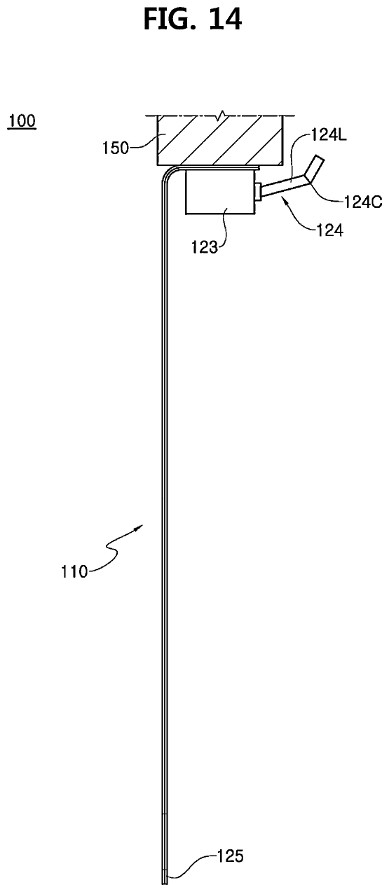

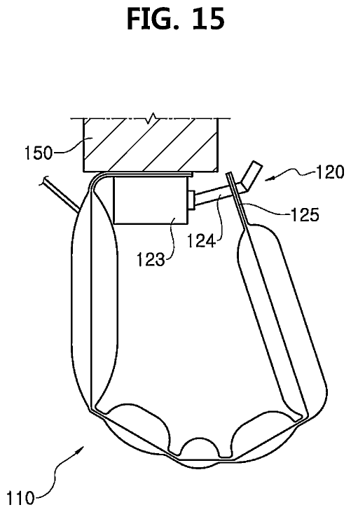

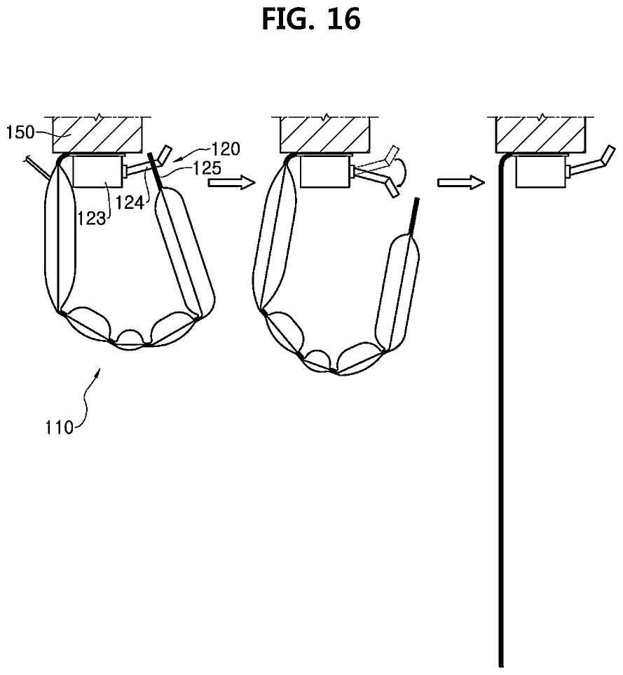

In the drawings, FIG. 14 is a perspective view illustrating an example of the gripper equipped with the latch and the ring as the locking means, FIG. 15 is a conceptual view illustrating a state in which the variable loop having a closed shape is locked by using the latch and the ring illustrated in FIG. 14, and FIG. 16 is a conceptual view illustrating a configuration in which the variable loop in the locked state in FIG. 15 is unlocked.

As illustrated in FIG. 14, one end of the variable loop 110 and the step motor 123 are mounted on the bottom surface of the transfer means 150.

A shaft of the step motor 123 is positioned horizontally, and the latch 124 is fixed to the shaft. The latch 124 may be an inclined straight bar 124L extending from an end of the shaft of the step motor 123, and a longitudinal middle portion of the straight bar 124L may be bent at an obtuse angle. The latch 124 is rotated by 180 degrees by the step motor 123 so that an end of the straight bar 124L is directed upward or rotated and then directed downward.

In case that the end of the straight bar 124L is directed upward, the end of the straight bar 124L and a bent point 124C are positioned to be higher than an extension line of the shaft of the step motor 123. On the contrary, in case that the end of the straight bar 124L is directed downward, the end of the straight bar 124L and the bent point are positioned to be lower than the extension line of the shaft of the step motor 123.

Meanwhile, the ring 125 is formed at an end of the variable loop 110. The ring 125 is locked by being caught by the latch of the step motor 123, or the ring 125 is unlocked while separating from the latch 124.

As illustrated in FIGS. 15 and 16, when the air is injected into the variable loop 110, the variable loop 110 changes to the closed shape while being curved. In this case, the ring 125 positioned at the free end of the variable loop 110 moves toward the step motor 123, and as a result, the ring 125 of the variable loop 110 is penetrated by the latch 124 of the step motor 123. In this case, the end of the straight bar 124L is positioned to be directed downward so that the latch 124 may easily pass through the ring 125. In this state, when the straight bar 124L passes through the ring 125, the step motor 123 operates to rotate the straight bar 124L so that the end of the straight bar 124L is directed upward. Therefore, the ring 125 is positioned on the straight bar 124L, and the ring 125 is about to be moved by a load of the variable loop 110 and a load of the object, such that the ring 125 is caught by the latch 124, and the variable loop 110 is locked in the closed shape.

In this state, when the end of the straight bar 124L is rotated downward by the operation of the step motor 123, the ring 125 slips downward softly along the straight bar 124L, such that the ring 125 is unlocked while separating from the straight bar 124L, i.e., the latch 124.

Meanwhile, a modified example will be described below in which a gripper having spiral loops is selected as the locking means 120. In this case, spiral loops 135 surround and fix the second enlarged portion 113B, i.e., the free end of the variable loop 110, such that the variable loop 110 may grip a long object, and the spiral loop 135 may grip an object having a short length and a large width. Therefore, objects with various shapes may be gripped.

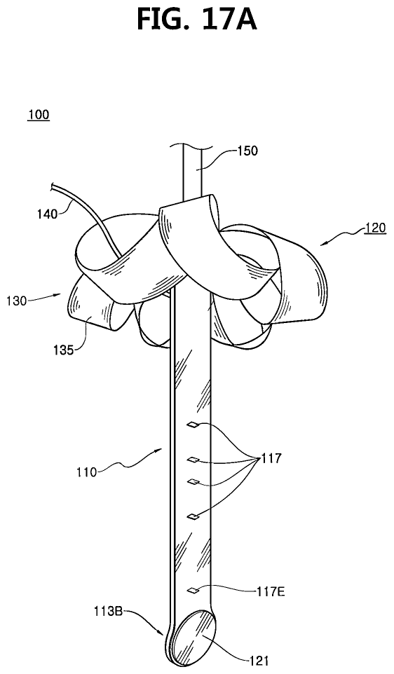

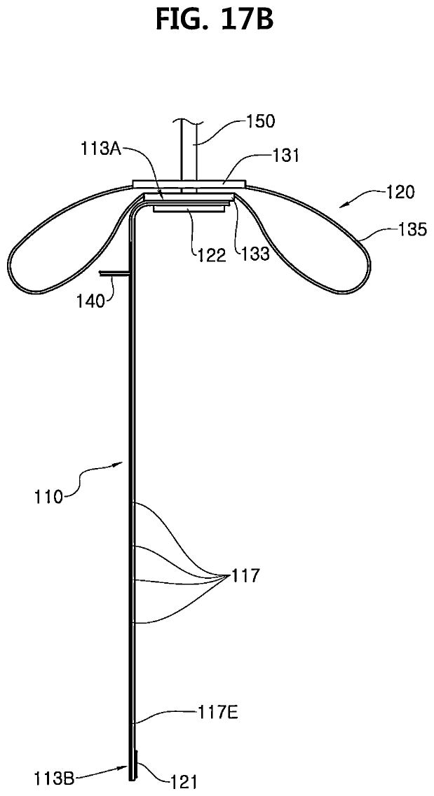

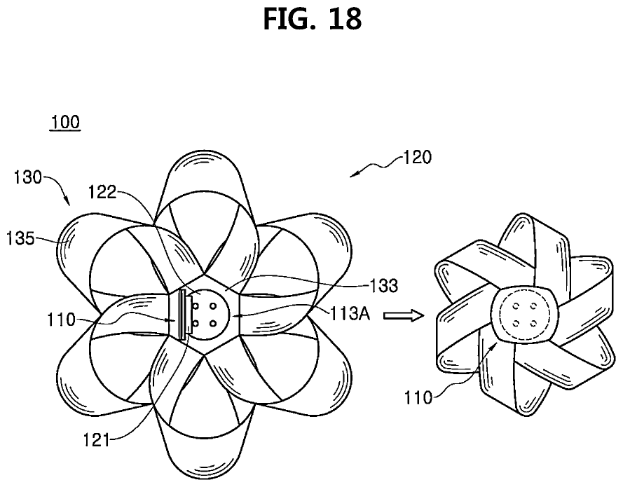

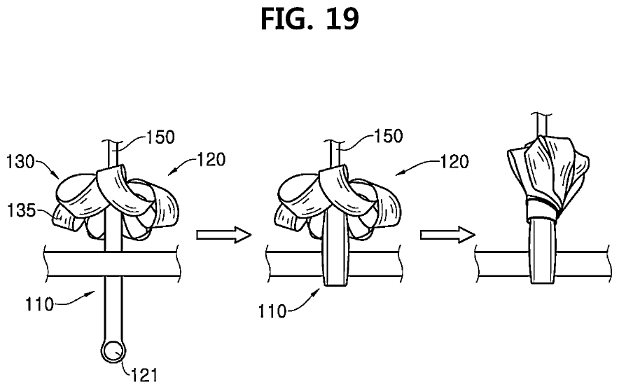

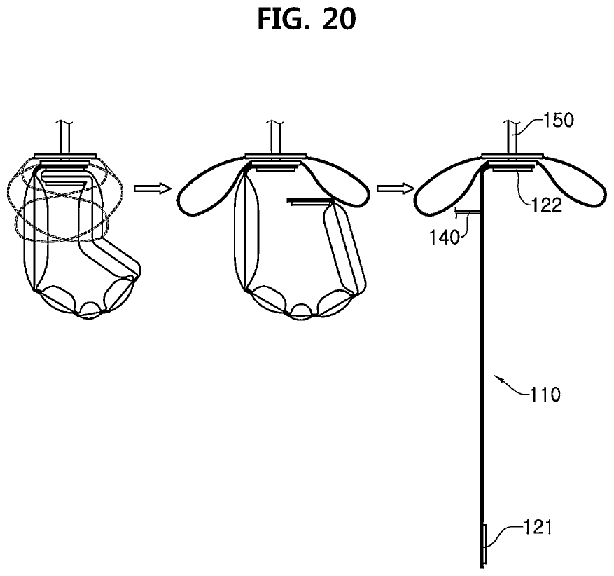

In the drawings, FIG. 17A is a perspective view illustrating a modified example of the gripper according to the present disclosure in which the locking means is configured as spiral loops, and FIG. 17B is a conceptual view illustrating a cross-section of the gripper illustrated in FIG. 17A. FIG. 18 is a conceptual view illustrating an operational relationship of the spiral loops when viewed from the bottom side, and FIG. 19 is a conceptual view illustrating a process in which the variable loop illustrated in FIG. 17A is locked while changing to a closed shape as air is injected into the variable loop. Further, FIG. 20 is a conceptual view illustrating a configuration in which the spiral loops grip the object in a state in which the variable loop illustrated in FIG. 17 is opened. Further, FIG. 20 is a conceptual view illustrating a configuration in which the spiral loops grip the object in a state in which the variable loop illustrated in FIG. 17 is opened.

A gripper 130 having the spiral loops is disclosed in Korean Patent No. 10-2555319 (Jul. 14, 2023).

The configuration will be described. The gripper includes an upper plate 131, a lower plate 133 configured to rotate relative to the upper plate 131, and a plurality of spiral loops 135 each having two opposite ends respectively connected to the upper plate 131 and the lower plate 133 or extending from the upper plate 131 and the lower plate 133, the plurality of spiral loops 135 having twisted longitudinal middle portions. When the upper plate 131 and the lower plate 133 rotate relative to each other, the longitudinal middle portions of the spiral loops 135 converge or diverge.

As described above, the spiral loops 135 converge or diverge as the upper plate 131 and the lower plate 133 rotate relative to each other. The spiral loops 135 converge to grip an object positioned therein, and the spiral loop 135 diverge and spread to release an object.

The gripper 130, which has the spiral loops 135 configured as described above, may be selected and adopted as the locking means 120 of the gripper 100 having the variable loop 110 according to the present disclosure.

As illustrated in FIGS. 17A to 20, the first enlarged portion 113A of the variable loop 110 is fixed to a central portion of the bottom surface of the lower plate 133, and the two opposite ends of each of the spiral loops 135 are respectively connected to the upper plate 131 and the lower plate 133 or extend from the upper plate 131 and the lower plate 133. The spiral loops 135 are disposed at equal angles in the state in which the longitudinal middle portions of the spiral loops 135 are twisted.

In this state, when the upper plate 131 and the lower plate 133 rotate relative to each other, the plurality of spiral loops 135 converge or diverge as described above. Meanwhile, when the variable loop 110 is changed to the closed shape by the air injected into the air chamber 115, the second enlarged portion 113B of the variable loop 110 enters the inside of the spiral loops 135. In this state, the spiral loops 135 converge to surround and bind the second enlarged portion 113B, thereby locking the closed shape.

Thereafter, when the upper plate 131 and the lower plate 133 rotate and the spiral loops 135 diverge and spread, the variable loop 110 is unlocked. When the air is discharged from the variable loop 110 in the unlocked state, the variable loop 110 is positioned vertically downward by the weight thereof.

In the case of the gripper 100 made by combining the spiral loops 135 and the variable loop 110 in the embodiment of the present disclosure, an object, which has a length larger than a diameter of a state in which the spiral loops 135 are spread, may be gripped by the variable loop 110, and an object, which has a length smaller than the diameter of the state in which the spiral loops 135 are spread, may be surrounded and gripped by the spiral loop 135.

Therefore, the gripper 100 made by combining the spiral loops 135 and the variable loop 110 may expand a range of objects that may be gripped and transferred.

The above-mentioned example has been described in which the variable loop 110 is curved when the air is injected into the air chamber 115 formed as a pneumatic actuator, and the variable loop 110 is deployed when the air is discharged. However, this example is just one example of the variable loop. Actuators, which have various shapes and are configured to be curved or deployed in response to an external signal, may be configured instead.

Variable loops configured as actuators different from the actuator using a pneumatic pressure will be described below.

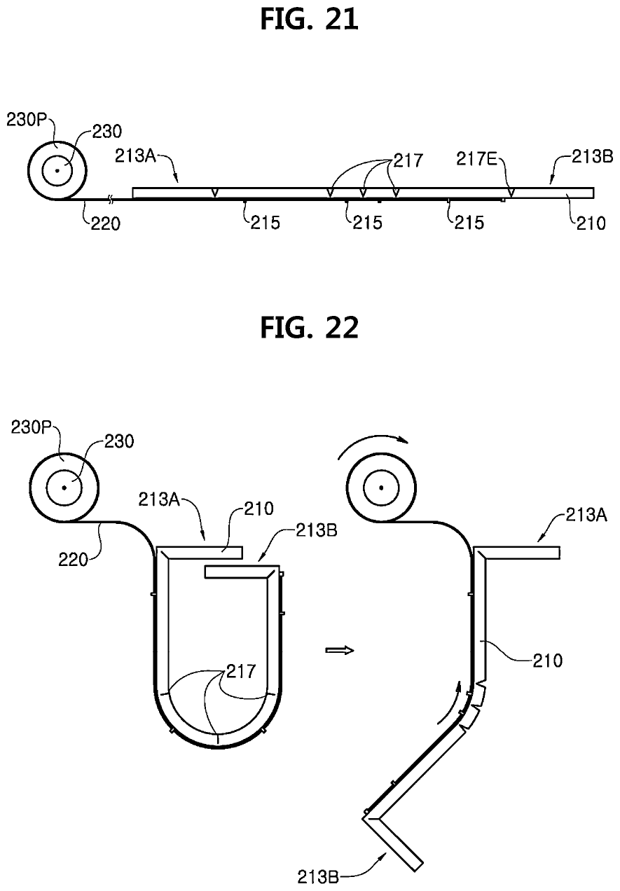

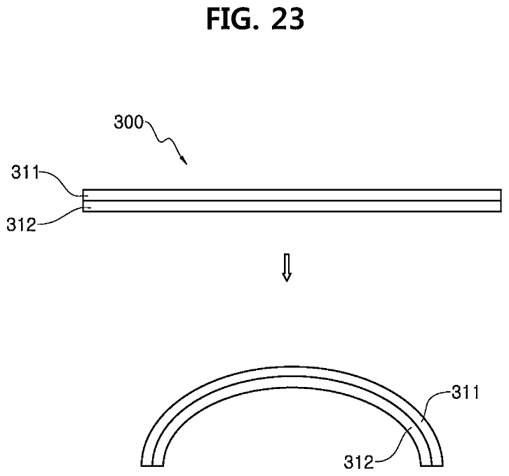

In the drawings, FIG. 21 is a conceptual view illustrating another embodiment of the variable loop, FIG. 22 is a conceptual view illustrating an operational relationship of the variable loop illustrated in FIG. 21, and FIG. 23 is a conceptual view illustrating still another embodiment of the variable loop.

As illustrated in FIG. 21, a variable loop with a mechanical mechanism includes a loop 210 made of a flexible PET material and having a long structure having a band shape, an elastic wire 220 extending along a length of the loop 210, and rings 215 formed at intervals along the length of the loop 210 and configured to surround the elastic wire 220.

In this case, folding portions 217 and 217E are formed on one surface of the loop 210 and disposed at intervals in a width direction along the length of the loop 210. The rings 215 are formed on the other surface of the loop 210 while corresponding to portions between the folding portions 217. The elastic wire 220 is positioned to penetrate the rings 215.

A longitudinal middle portion of the elastic wire 220 is kept in a curved shape like a ‘U’ shape. A free end portion of the elastic wire 220 is fixed to a free end portion 213B of the loop 210. The elastic wire 220 is fixed to a circumferential surface of a pulley 230P configured to be rotated by a motor 230. Therefore, when the motor 230 operates, the elastic wire 220 is wound around the circumferential surface of the pulley 230P or unwound from the circumferential surface of the pulley 230P.

An operational relationship of the variable loop configured as described above will be described. As illustrated in FIG. 22, the band-shaped loop 210 is kept in a shape curved along the ‘U’ shape of the elastic wire 220, i.e., kept in the closed shape. In this state, when the motor 230 operates so that the elastic wire 220 is wound around the pulley 230P, the elastic wire 220 moves, and the other end of the loop 210 is pulled by the elastic wire 220 and deployed to the opened shape from the closed shape.

On the contrary, when the motor 230 operates so that the elastic wire 220 is unwound from the pulley 230P, tension applied to the elastic wire 220 decreases, such that the elastic wire 220 is restored to an original shape, i.e., the curved shape like a ‘U’ shape. As the elastic wire 220 is restored, the loop 210 is also curved in a ‘U’ shape and kept in the closed shape.

The loop 210 surrounds and grips the object while being deformed from the opened state to the curved, closed shape as described above.

In addition to the use of the wire 220 and the motor 230, the gripper 130, which has the variable loop, the magnet 121 and the magnetic element 122 of the locking means 120, the unlocking part 128, the latch 124, the ring 215, and the spiral loops may be applied, such that the variable loop may be locked in the closed state or unlocked and deformed to be opened.

Meanwhile, while the variable loop using the wire 220 and the motor 230 is configured to be operated by the mechanical mechanism, a variable loop 130 to be described below is configured by using a variable material that is stretched or contracted by external stimuli such as electricity, heat, light, PH, or the like.

A variable loop 310 is formed by attaching polymers with different flexibility to external stimuli. When particular stimuli are applied to the variable loop 310 so that the variable loop 310 is stretched or contracted, the variable loop 310 is curved in a shape in which a polymer 312 having low flexibility is positioned inward, and a polymer 311 having high flexibility is positioned outward, as illustrated in FIG. 23.

In another embodiment, like a bimetal structure, a variable loop may be formed by attaching metallic materials having different flexibility to heat that is one of the external stimuli. In this case, the variable loop is configured such that a metallic material having low flexibility to heat is positioned inward based on the curved direction, and a metallic material having high flexibility is positioned outward, such that the variable loop is curved by heat that is an external signal. In this case, the folding portion is formed on an inner surface of the metallic material having low flexibility.

As described above, the variable loop may constitute the actuator by using the material selected from various materials. The variable loop may be curved in the closed shape or spread to be opened in response to the external signal in accordance with changes in external conditions such as air, electricity, heat, light, and PH. Further, the closed shape may be maintained by locking the curved, closed shape by using the locking means, such that the object, which is gripped when the variable loop is curved, may be lifted up by the transfer means. When the transfer means lifts up the object, the load of the object is supported by tension of the tendon included in the variable loop, such that the object may be lifted up by the tension of the tendon higher than the force generated by the operation of the actuator.

As described above, the variable tube of the present disclosure, which is the actuator, may be configured by any one type of material selected from various materials that are changed to the closed shape in response to the external signal. The above-mentioned technical features belong to the technical scope of the present disclosure.

### DESCRIPTION OF REFERENCE NUMERALS

100: Gripper
110: Variable loop
111, 111A, 111B, 128E: Elastic member
113, 113A, 113B, 213A, 213B: Enlarged portion
115, 115A, 115B, 128C: Air chamber
117, 117E: Folding portion
120: Locking means
121: Permanent magnet
122: Magnetic element
123: Step motor
124: Latch
125: Ring
127: Locking part
128: Unlocking part
131: Upper plate
133: Lower plate
135: Spiral loop
140, 128H: Hose
150: Transfer means
210: Loop
215: Ring
217: Folding portion
220: Elastic wire
230: Motor
310: Variable loop
311, 312: Polymer

What is claimed is:

1. A gripper comprising:
a variable loop configured to surround and grip an object while being curved in response to an external signal; and
a locking means configured to lock the variable loop when the variable loop is curved in a closed shape to maintain the closed shape,
wherein one end of the variable loop is fixed to a transfer means.

2. The gripper of claim 1, wherein the variable loop has a band shape, and a plurality of elastic members with a band shape is joined to one another along edges thereof to form an air chamber therein.

3. The gripper of claim 2, wherein one or more folding portions, where the elastic members are joined, are formed in a longitudinal middle portion of the air chamber in a width direction of the air chamber, and the folding portion is joined to have a length smaller than a width of the air chamber so that air flows.

4. The gripper of claim 1, wherein the variable loop is made of a flexible material and has a band shape, folding portions are formed on a curved inner surface of the variable loop and disposed at intervals, and rings are formed on an outer surface of the variable loop and disposed at intervals in a longitudinal direction of the variable loop, and
wherein the gripper comprises:
a wire having an end fixed to an end of the variable loop and configured to penetrate the ring and extend in the longitudinal direction of the variable loop; and
a motor configured to move the wire.

5. The gripper of claim 4, wherein the wire is a bent elastic wire, the variable loop has a closed shape curved along a shape of the elastic wire, and the variable loop changes to an opened shape as the wire is moved to the outside of variable loop by the motor.

6. The gripper of claim 1, wherein the variable loop is made by attaching two types of materials that are differently stretched or contracted in response to the external signal, and the variable loop is curved in the closed shape or deployed in an opened shape in response to the external signal.

7. The gripper of claim 6, wherein the variable loop is made by attaching polymers with different flexibility.

8. The gripper of claim 6, wherein the variable loop is made by attaching metallic materials with different flexibility.

9. The gripper of claim 1, wherein the locking means includes a magnet and a magnetic element, one of the magnet and the magnetic element is fixed to one of two opposite ends of the variable loop or the transfer means, and the other of the magnet and the magnetic element is fixed to a free end that is the other end of the variable loop,
wherein when the variable loop is curved in the closed shape, the magnet and the magnetic element are attached by an attractive force to maintain the closed shape, and
wherein the free end of the variable loop is positioned between the magnet and the magnetic element that are attached to each other.

10. The gripper of claim 9, wherein enlarged portions are respectively formed at two opposite ends of the variable loop, the first enlarged portion formed at one end of the variable loop is fixed to the transfer means, and the locking means is fixed to the first enlarged portion and the second enlarged portion formed at the free end of the variable loop.

11. The gripper of claim 2, wherein a second enlarged portion is formed at a free end of the variable loop, and folding portions are formed forward and rearward of the second enlarged portion in a direction in which air is introduced into the air chamber.

12. The gripper of claim 2, wherein a hose is connected to the air chamber of the variable loop, and the gripper further comprises a pneumatic system configured to inject or discharge air through the hose.

13. The gripper of claim 12, wherein a second enlarged portion is formed at a free end of the variable loop, and an air chamber provided separately from the air chamber of the variable loop is formed in the second enlarged portion.

14. The gripper of claim 13, further comprising:
a pneumatic system having hoses respectively connected to the air chamber of the variable loop and the air chamber of the second enlarged portion, the pneumatic system being configured to inject or discharge air selectively into or from any one air chamber or both of the air chambers.

15. The gripper of claim 1, wherein the locking means includes a latch and a ring, the ring is fixed to a free end portion of the variable loop, the latch is rotatably fixed to a shaft of a motor, the latch penetrates the ring when the variable loop is curved in the closed shape, the ring is locked so as not to be separated from the latch as the latch is rotated by an operation of the motor, and the ring is unlocked while slipping off and separating from the latch as the latch is rotated by the motor, wherein the motor is fixed to one end of the variable loop or the transfer means.

16. The gripper of claim 15, wherein the latch is an inclined straight bar extending from an end of the horizontal shaft of the motor, and a longitudinal middle portion of the straight bar is bent at an obtuse angle.

17. The gripper of claim 1, wherein the locking means is a gripper having a plurality of spiral loops configured to converge or diverge, and one end of the variable loop is fixed inside the spiral loops,
wherein when the variable loop is curved in the closed shape, the spiral loops converge to lock and bind a free end of the variable loop, and
wherein the variable loop is unlocked as the spiral loops diverge.

18. The gripper of claim 17, wherein the gripper having the plurality of spiral loops configured to converge or diverge comprises:
an upper plate mounted on the transfer means,
a lower plate configured to rotate relative to the upper plate; and
the plurality of spiral loops having two opposite ends respectively connected to the upper plate and the lower plate or extending from the upper plate and the lower plate, the plurality of spiral loops having twisted longitudinal middle portions,
wherein the longitudinal middle portions of the spiral loops converge or diverge as the upper plate and the lower plate rotate relative to each other, and
wherein an enlarged portion is formed at a free end of the variable loop, and the spiral loops surround and bind the enlarged portion.

19. The gripper of claim 1, wherein the locking means comprises a locking part and an unlocking part, the locking part comprises a magnet and a magnetic element, any one of the magnet and the magnetic element is fixed to one of two opposite ends of the variable loop or the transfer means, the other of the magnet and the magnetic element is fixed to a free end that is the other end of the variable loop, and when the variable loop is curved in the closed shape, the magnet and the magnetic element are attached by an attractive force to maintain the closed shape.

20. The gripper of claim 19, wherein the unlocking part is an elastic member formed in an air chamber in the variable loop, the elastic member is fixed to a bottom surface of the magnetic element, the elastic member is expanded by air injected into the air chamber or contracted as the air is discharged, and a free end of the variable loop is attached to a bottom surface of the unlocking part.
